(19) United States
(12) Patent Application Publication
(10) Pub. No.: US 2024/0102874 A1
(43) Pub. Date: Mar. 28, 2024

(54) Mechanical Brake Chain Sensor

(71) Applicant: Walter Wayne Precure, Canyon, TX (US)

(72) Inventor: Walter Wayne Precure, Canyon, TX (US)

(21) Appl. No.: 18/475,203

(22) Filed: Sep. 26, 2023

Related U.S. Application Data
(60) Provisional application No. 63/377,069, filed on Sep. 26, 2022.

(51) Int. Cl. G01L 5/04; B61L 15/00

(52) U.S. Cl. CPC G01L 5/04; B61L 15/0081

(57) ABSTRACT

A chain tension sensor for monitoring a chain between cars in a locomotive. The chain tension sensor comprises a first link assembly and a second link assembly, referred to collectively as the link assemblies. each among the link assemblies comprises a U-link having a first end and a second end, a first spring, a second spring, a first fastener, a second fastener and a sensor base. The U-link of the link assemblies is a “u” shaped member having a curved end pointing outward from one another and an open end of the “u” facing inward toward one another. each among the link assemblies are arranged with the curved end extending out from the sensor base. The chain tension sensor is configured to monitor a signal between one or more sensors of the sensor base of the link assemblies to determine a proximity of the chain tension sensors.

### CROSS-REFERENCE TO RELATED APPLICATIONS

This application claims benefit to and incorporates by reference U.S. provisional application No. 63/377,069, filed on 2022 Sep. 26.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

Various systems for monitoring braking systems have been developed. For example, US 2021/0053548 A1 introduces a load measuring device to be attached to the undercarriage of railway assets. However, '548 does not account for the redundant use of a chain 102 and its status, which would be helpful to operators of a locomotive 104.

### BRIEF SUMMARY OF THE INVENTION

A chain tension sensor for monitoring a chain between cars in a locomotive. Said chain tension sensor comprises a first link assembly and a second link assembly, referred to collectively as the link assemblies. each among said link assemblies comprises a U-link having a first end and a second end, a first spring, a second spring, a first fastener, a second fastener and a sensor base. Said U-link of said link assemblies is a “u” shaped member having a curved end pointing outward from one another and an open end of the “u” facing inward toward one another. each among said link assemblies is arranged with said curved end extending out from said sensor base. Said chain tension sensor is configured for transitioning between a relaxed configuration and a first pulled configuration, and measuring a relative proximity between said sensor base of said first link assembly and said second link assembly.

### BRIEF DESCRIPTION OF THE SEVERAL VIEWS OF THE DRAWING

FIG. 1 illustrates an elevated side view of a locomotive 104 and a detailed view of a mechanical brake assembly 100.

FIGS. 2A and 2B illustrate an elevated side view of a pulley based mechanical brake assembly 206 with a chain tension sensor assembly 200 and with a chain 102 in a non-engaged configuration 202 and an engaged configuration 204.

FIGS. 3A and 3B illustrate an elevated side view of a rocker based mechanical brake assembly 300 with said chain tension sensor assembly 200 and with said chain 102 in said non-engaged configuration 202 and said engaged configuration 204.

FIGS. 4A and 4B illustrate two perspective overviews of said chain tension sensor assembly 200 and of a first link assembly 400a, respectively.

FIGS. 5A and 5B illustrate an exploded perspective overview of said first link assembly 400a and said chain tension sensor assembly 200.

FIGS. 6A and 6B illustrate two exploded perspective overview of a second link assembly 400b.

FIGS. 7A and 7B illustrate two perspective overviews of said second link assembly 400b.

FIGS. 8A and 8B illustrate an elevated top view of said chain tension sensor assembly 200 in a relaxed configuration 800 in hidden line and wireframe rendering, respectively.

FIG. 8C illustrates a wireframe elevated top view of said chain tension sensor assembly 200 in a range of intermediate pulled configurations 802.

FIG. 9A illustrates a wireframe elevated top view of said chain tension sensor assembly 200 in a fully compressed configuration 900.

FIGS. 9B and 9C illustrate an elevated side and top view of said second link assembly 400b.

FIG. 10 illustrates a perspective overview of said chain tension sensor assembly 200 on said chain 102 in said range of intermediate pulled configurations 802.

FIG. 11 illustrates a perspective overview of said chain tension sensor assembly 200 on said chain 102 in said relaxed configuration 800.

FIG. 12 illustrates a block diagram of a chain sensor address space 1200 of a sensor controller 700.

FIGS. 13A and 13B illustrate an alternate chain tension sensor 1300.

FIG. 14 illustrates an exploded perspective overview of said alternate chain tension sensor 1300.

FIGS. 15A and 15B illustrate a perspective overview of said second link assembly 400b of said alternate chain tension sensor 1300.

FIGS. 16 and 17 illustrate said alternate chain tension sensor 1300 in said relaxed configuration 800, and said range of intermediate pulled configurations 802, respectively.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

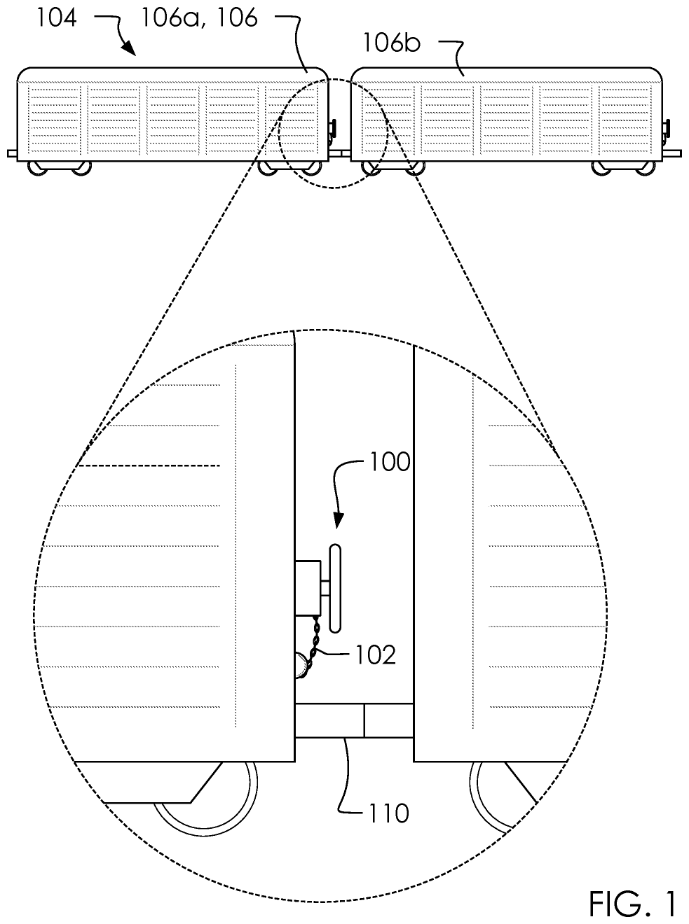

FIG. 1 illustrates an elevated side view of a locomotive 104 and a detailed view of a mechanical brake assembly 100.

In one embodiment, said mechanical brake assembly 100 can comprise a chain 102.

Logistics companies which run and manage locomotives are heavily regulated for safety of said locomotive 104 between a plurality of train cars 106, such as a first car 106a and a second car 106b.

In one embodiment, said locomotive 104 can comprise a first brake system comprising an airbrake controlled centrally for all among said plurality of train cars 106, and a second comprising said mechanical brake assembly 100 which is manually set and released on each among said plurality of train cars 106, as is known in the art.

In one scenario, said mechanical brake assembly 100 can be set to braking and not released prior to operating said locomotive 104. Wherein, pulling said plurality of train cars 106 with a brake engaged, damage can be done to tracks, wheels, and the surroundings environment due to sparks. Accordingly, it would be advantageous to know if said mechanical brake assembly 100 is engaged prior to operating said locomotive 104.

Various systems for monitoring braking systems have been developed. For example, US 2021/0053548 A1 introduces a load measuring device to be attached to the undercarriage of railway assets. However, '548 does not account for the redundant use of said chain 102 and its status, which would be helpful to operators of said locomotive 104.

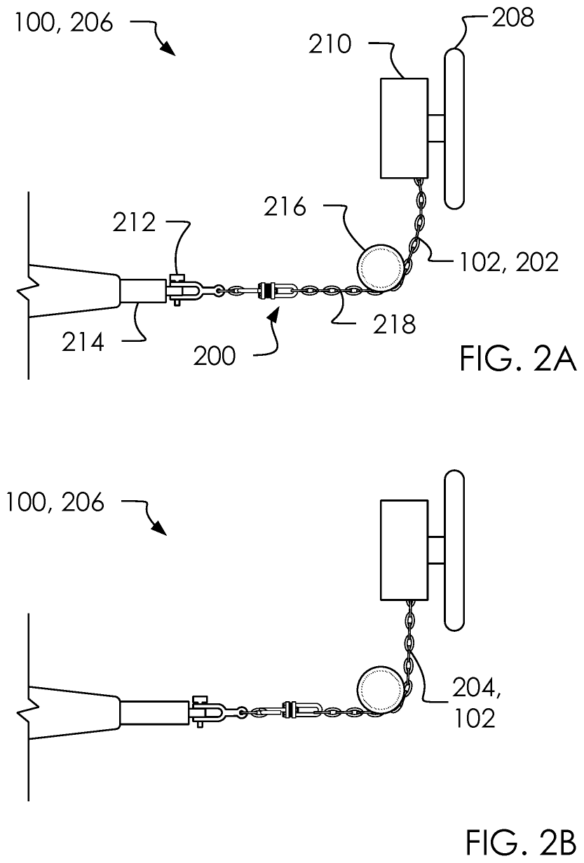

FIGS. 2A and 2B illustrate an elevated side view of a pulley based mechanical brake assembly 206 with a chain tension sensor assembly 200 and with said chain 102 in a non-engaged configuration 202 and an engaged configuration 204.

In one embodiment, said pulley based mechanical brake assembly 206 can comprise one configuration of said mechanical brake assembly 100.

In one embodiment, said mechanical brake assembly 100 can comprise a wheel 208, a chain box 210, said chain 102, a brake pin assembly 212, and a brake cylinder 214. In said pulley based mechanical brake assembly 206, said mechanical brake assembly 100 further comprises a pulley 216.

With said mechanical brake assembly 100 in said non-engaged configuration 202, said chain 102 can be slack; and in said engaged configuration 204, said chain 102 can be tight, as illustrated.

In one embodiment, said chain tension sensor assembly 200 can be attached along said chain 102 between said brake pin assembly 212 and said chain box 210. For example, said chain tension sensor assembly 200 can be between said brake cylinder 214 and said pulley 216, as illustrated.

Said chain tension sensor assembly 200 can be configured to determine whether said chain 102 is in said non-engaged configuration 202 or said engaged configuration 204.

Said brake pin assembly 212 can attach said chain 102 to said brake cylinder 214.

Said brake cylinder 214 can be configured to engage said mechanical brake assembly 100 on one among said plurality of train cars 106, as is known in the art.

Said chain tension sensor assembly 200 can be configured to monitor a tension in said chain 102 by installing said chain tension sensor assembly 200 in series between a plurality of chain links 218 and monitoring a force exerted on said chain tension sensor assembly 200 by portions of said chain 102.

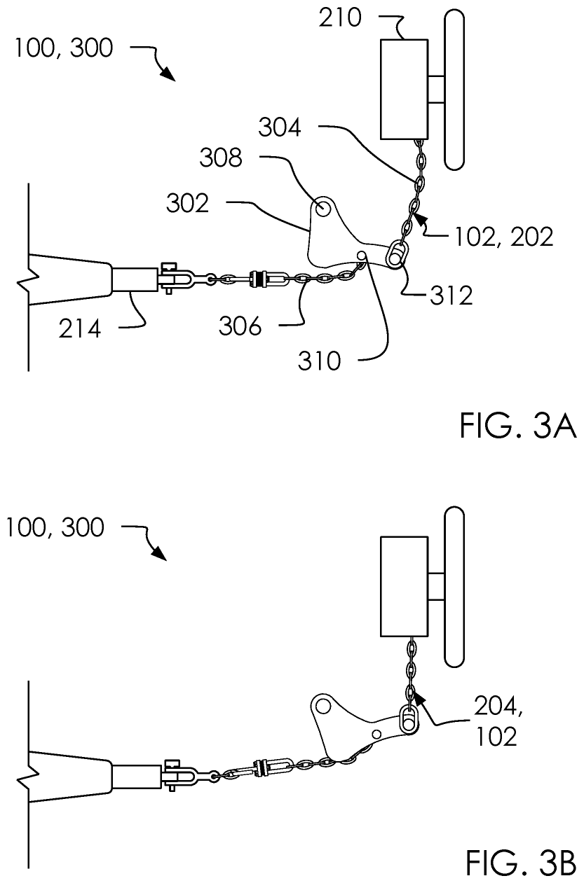

FIGS. 3A and 3B illustrate an elevated side view of a rocker based mechanical brake assembly 300 with said chain tension sensor assembly 200 and with said chain 102 in said non-engaged configuration 202 and said engaged configuration 204.

In one embodiment, said mechanical brake assembly 100 with a rocker 302 rather than said pulley 216 can be referred to as said rocker based mechanical brake assembly 300.

In one embodiment, said chain 102 can comprise a first chain 304 and a second chain 306; wherein said first chain 304 connects said chain box 210 to said rocker 302, and said second chain 306 connects said rocker 302 to said brake cylinder 214.

In one embodiment, said rocker 302 can comprise a rotation axis 308, a first chain receiver 310 and a second chain receiver 312.

With said mechanical brake assembly 100 comprising said rocker based mechanical brake assembly 300, said chain tension sensor assembly 200 can be attached to a portion of said second chain 306 or said first chain 304, provided said chain tension sensor assembly 200 does not interfere with said rocker 302 or said chain box 210 and can sense tension on said chain 102.

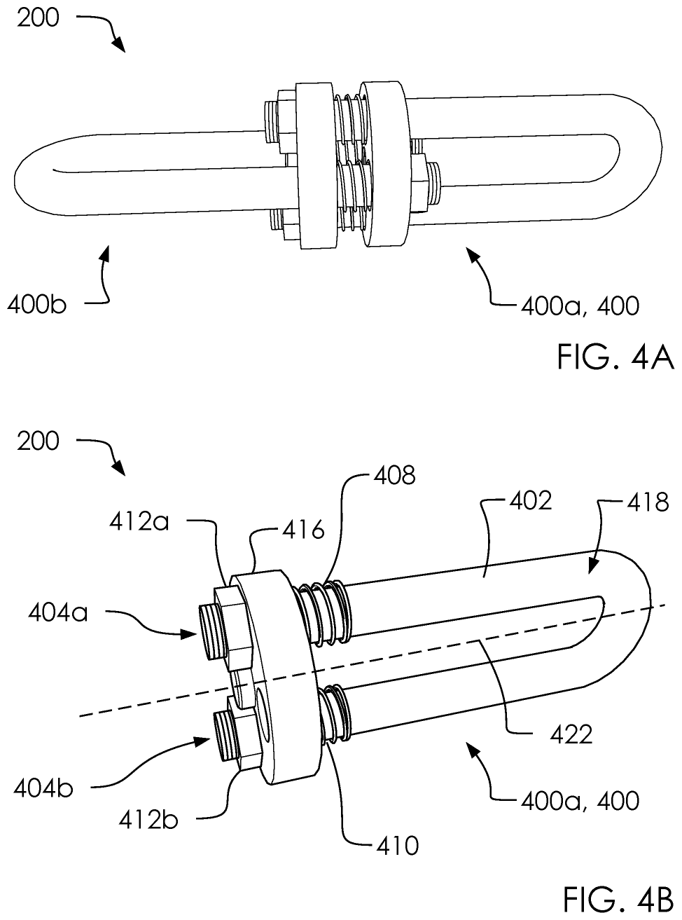

FIGS. 4A and 4B illustrate two perspective overviews of said chain tension sensor assembly 200 and of a first link assembly 400a, respectively.

In one embodiment, said chain tension sensor assembly 200 can comprise said first link assembly 400a and a second link assembly 400b, referred to collectively as two link sensor assemblies 400. Each among said two link sensor assemblies 400 can comprise a sensor-chain link 402 and a sensor base 416.

Said sensor-chain link 402 can comprise a “U” shaped rod-like object having an enclosed end 418 and an open end 420. Wherein, said open end 420 is between a link first end 404a and a link second end 404b, and said enclosed end 418 extends out and away from said open end 420.

Each said sensor-chain link 402 is configured to selectively attach to said sensor base 416 using said open end 420 and one or more fasteners.

For example, in one embodiment, said sensor-chain link 402 is configured for passing through a portion of said sensor base 416 and securing said open end 420 to said sensor base 416 using a first fastener 412a and a second fastener 412b attached to said link first end 404a and said link second end 404b, respectively. In one embodiment, said sensor-chain link 402 can further be secured to said sensor base 416 using link springs 408 arranged between said sensor base 416, said first fastener 412a and said second fastener 412b.

Said link springs 408 comprise a first spring 408a and a second spring 408b.

With said two link sensor assemblies 400 attached to one another, said open end 420 of said first link assembly 400a and said second link assembly 400b face one another, and said enclosed end 418 extend out away from one another.

Said sensor-chain link 402 can comprise a center axis 422 can be aligned an anticipated direction of tension applied on said sensor-chain link 402 along said chain 102.

In one embodiment, said sensor-chain link 402 of said first link assembly 400a and said sensor-chain link 402 of said second link assembly 400b can be aligned with one another along said center axis 422, but 90 degrees rotated relative to one another about said center axis 422 such that said link first end 404a and said link second end 404b can overlap with one another without interfering with one another.

In one embodiment, each among said two link sensor assemblies 400 can be arranged with said enclosed end 418 extending out from said sensor base 416.

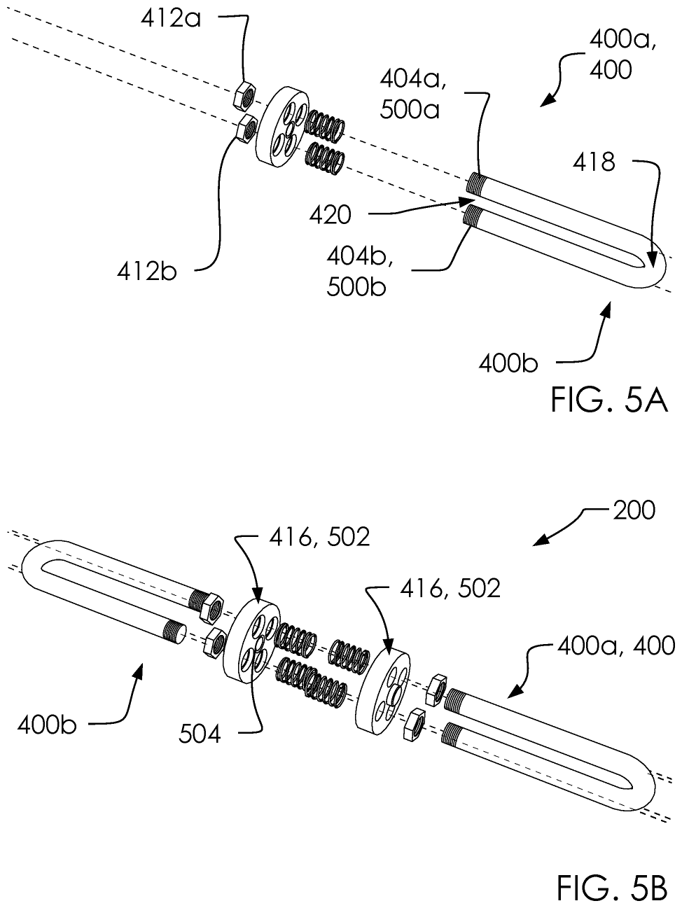

FIGS. 5A and 5B illustrate an exploded perspective overview of said first link assembly 400a and said chain tension sensor assembly 200.

In one embodiment, said sensor-chain link 402 can comprise a first threading 500a and a second threading 500b on said link first end 404a, and said link second end 404b, respectively. In one embodiment, each among said first threading 500a and said second threading 500b can be threaded and configured to selectively attach to said first fastener 412a, and said second fastener 412b, respectively.

In one embodiment, said chain tension sensor assembly 200 can comprise two sensor bases 502 comprising said sensor base 416 of said first link assembly 400a and said sensor base 416 of said second link assembly 400b. Said two sensor bases 502 can be configured to extend through a portion of both said sensor-chain link 402 of said first link assembly 400a and said second link assembly 400b, as illustrated.

In one embodiment, said two sensor bases 502 can each comprise one or more sensors 504 configured to measure a proximity between said two sensor bases 502.

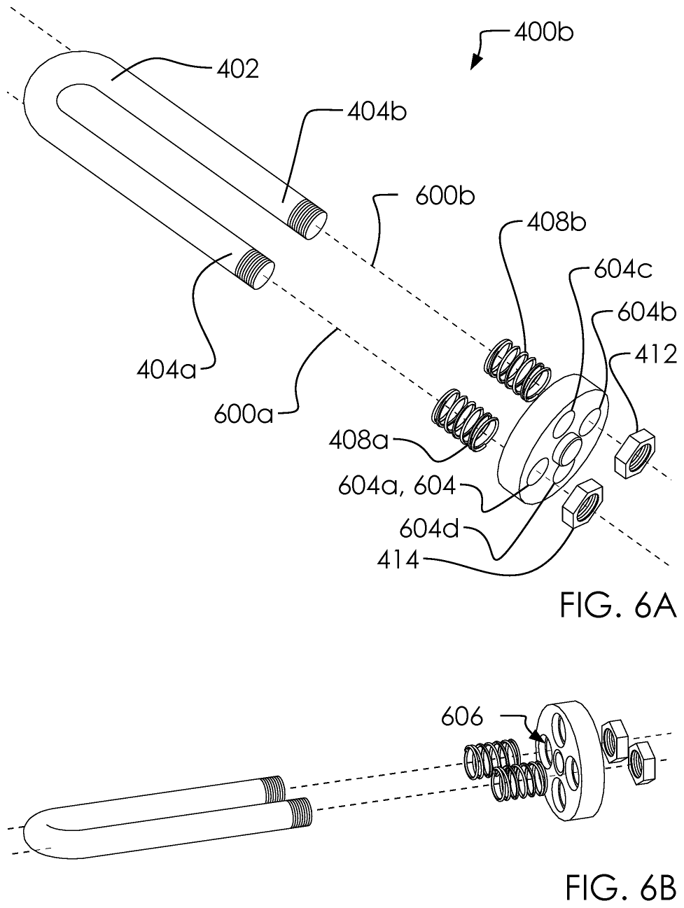

FIGS. 6A and 6B illustrate two exploded perspective overview of said second link assembly 400b.

In one embodiment, said link first end 404a, and said link second end 404b of said sensor-chain link 402 can be aligned with a first axis 600a and a second axis 600b, respectively.

In one embodiment, said sensor base 416 can comprise a plurality of apertures 604 comprising a first aperture 604a, a second aperture 604b, a third aperture 604c, and a fourth aperture 604d. In one embodiment, said link first end 404a, and said link second end 404b of said two link sensor assemblies 400 can pass through said plurality of apertures 604, as illustrated.

In one embodiment, said plurality of apertures 604 can comprise two sets of two aperture each aligned 90 degrees out of phase from one another about said center axis 422, as illustrated and discussed herein.

In one embodiment, said plurality of apertures 604 can comprise a recessed portion 606 configured to allow a portion of said first spring 408a and said second spring 408b to slide within said sensor base 416. In one embodiment, said recessed portion 606 can ensure pressure on said one or more sensors 504 within said two sensor bases 502 does not destroy said one or more sensors 504 by ensuring said link springs 408 can fully compress without being smashed between said two sensor bases 502.

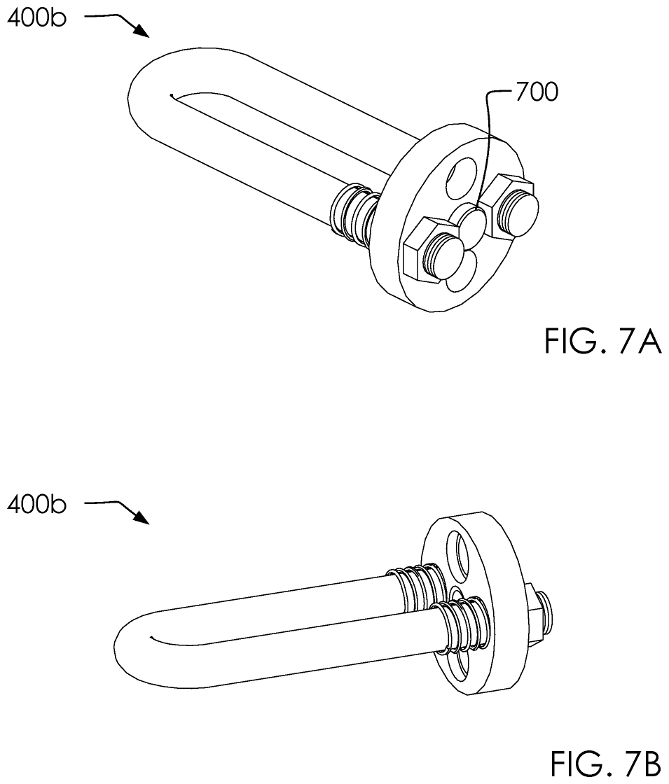

FIGS. 7A and 7B illustrate two perspective overviews of said second link assembly 400b.

In one embodiment, each among said two sensor bases 502 can comprise a sensor controller 700. In one embodiment, said sensor controller 700 can comprise a computer configured to collect and report a status of said one or more sensors 504 of said two sensor bases 502.

Said sensor controller 700 and said one or more sensors 504 can comprise a different physical appearance and function like those discussed herein.

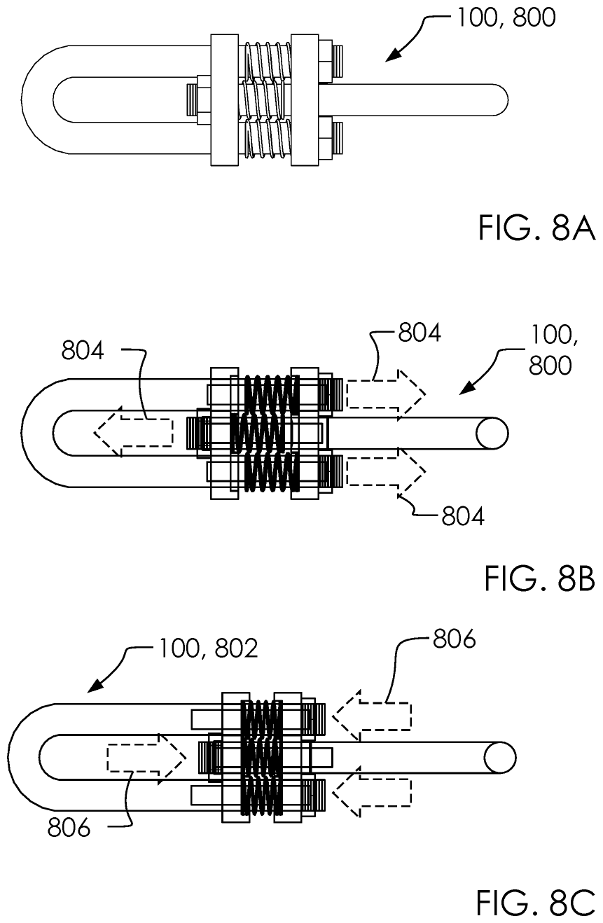

FIGS. 8A and 8B illustrate an elevated top view of said chain tension sensor assembly 200 in a relaxed configuration 800 in hidden line and wireframe rendering, respectively.

Said first spring 408a and said second spring 408b are configured to press said sensor base 416 of each said first link assembly 400a and said second link assembly 400b into one another as discussed herein.

With said mechanical brake assembly 100 in said relaxed configuration 800, portions of said link springs 408 can rest within said sensor base 416; whereas, with said mechanical brake assembly 100 in a range of intermediate pulled configurations 802, said link springs 408 can be squeezed within a portion or entirely within said recessed portion 606 of said plurality of apertures 604. Wherein, in one embodiment, each said sensor base 416 of said first link assembly 400a and said second link assembly 400b can touch one another without crushing said link springs 408.

FIG. 8C illustrates a wireframe elevated top view of said chain tension sensor assembly 200 in said range of intermediate pulled configurations 802.

In one embodiment, said chain tension sensor assembly 200 can be configured for transitioning between said relaxed configuration 800, said range of intermediate pulled configurations 802 and a fully compressed configuration 900. Further said chain tension sensor assembly 200 can be configured for measuring a relative proximity between said sensor base 416 of said first link assembly 400a and said second link assembly 400b.

In one embodiment, said first spring 408a, and said second spring 408b are configured to apply a spring force 804 pulling said two link sensor assemblies 400 toward one another. In one embodiment, with said chain tension sensor assembly 200 installed in said chain 102, a chain force 806 can pull said sensor base 416 of each said two link sensor assemblies 400 apart from one another.

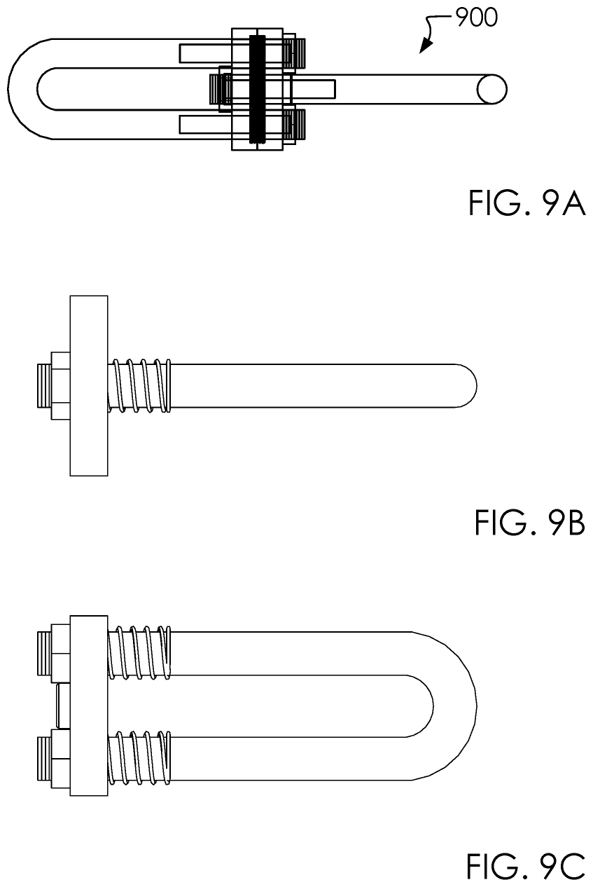

FIG. 9A illustrates a wireframe elevated top view of said chain tension sensor assembly 200 in said fully compressed configuration 900.

In one embodiment, with said chain tension sensor assembly 200 in said fully compressed configuration 900, said sensor base 416 of each said two link sensor assemblies 400 can be pulled completely against one another with said one or more sensors 504 at a minimum distance from one another.

In one embodiment, said chain tension sensor assembly 200 can be configured to monitor a signal between said one or more sensors 504 of said sensor base 416 of said two link sensor assemblies 400 to determine whether said chain tension sensor assembly 200 is in said fully compressed configuration 900, said range of intermediate pulled configurations 802 and said relaxed configuration 800.

FIGS. 9B and 9C illustrate an elevated side and top view of said second link assembly 400b.

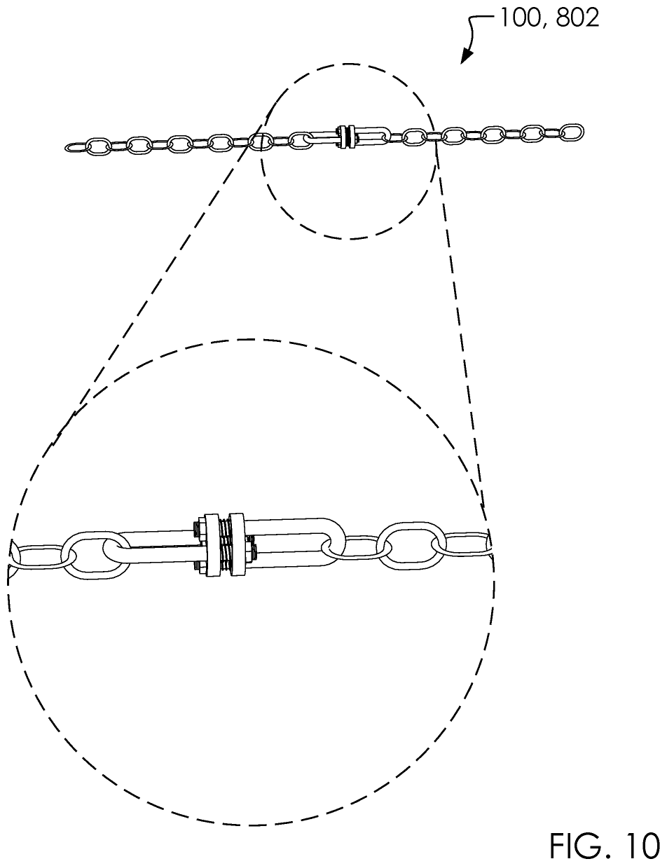

FIG. 10 illustrates a perspective overview of said chain tension sensor assembly 200 on said chain 102 in said range of intermediate pulled configurations 802.

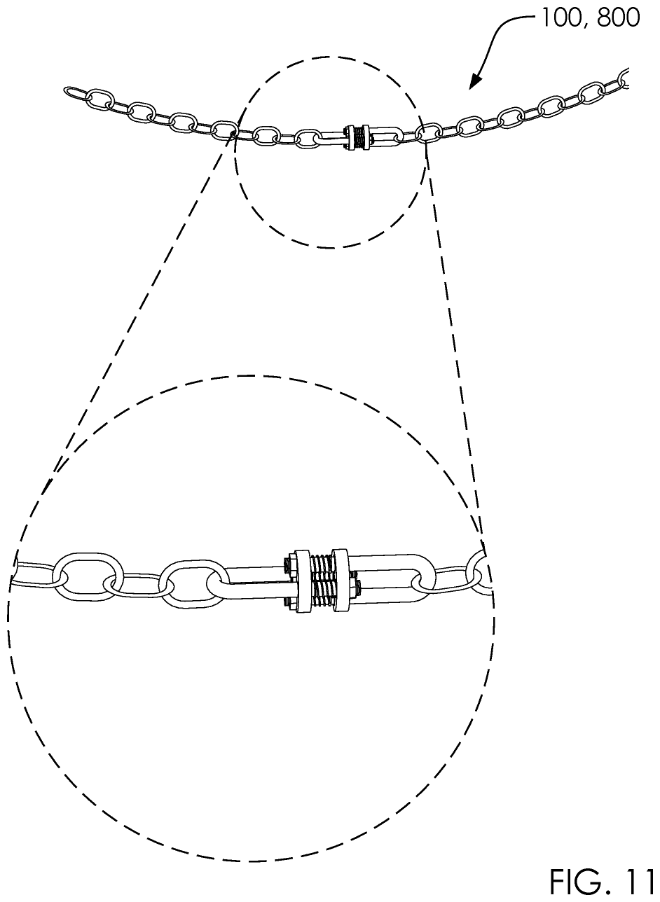

FIG. 11 illustrates a perspective overview of said chain tension sensor assembly 200 on said chain 102 in said relaxed configuration 800.

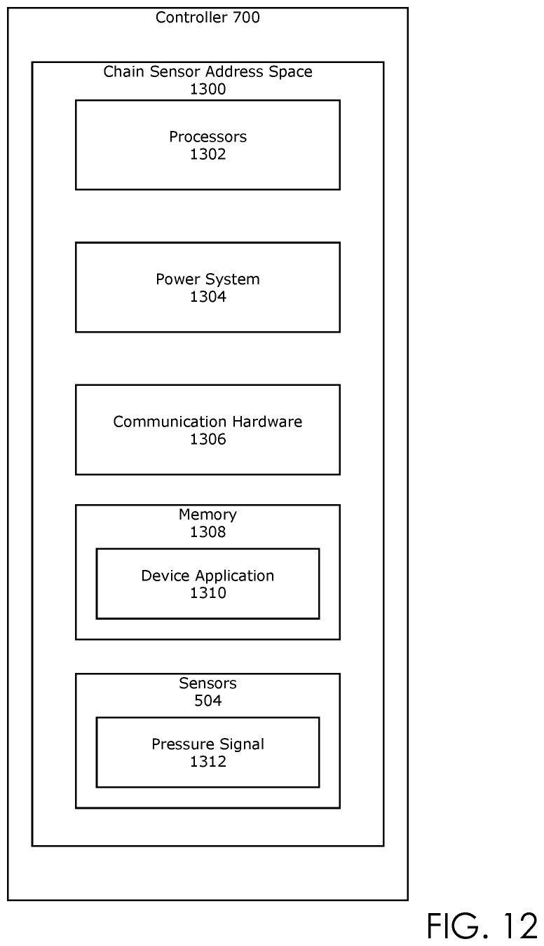

FIG. 12 illustrates a block diagram of a chain sensor address space 1200 of said sensor controller 700.

In one embodiment, said chain sensor address space 1200 can comprise one or more processors 1202, a power system 1204, a communication hardware 1206, a memory 1208 having a device application 1210 and said one or more sensors 504. In one embodiment, said one or more sensors 504 can be configured to read a pressure signal 1214. In one embodiment, said pressure signal 1214 can comprise a pressure between said sensor base 416 of said first link assembly 400a and said second link assembly 400b.

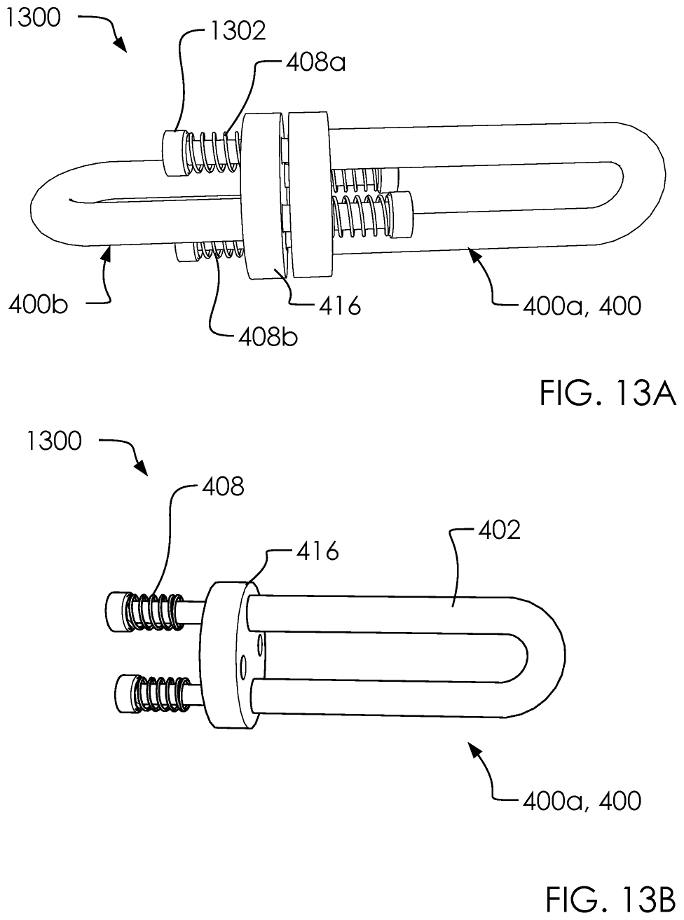

FIGS. 13A and 13B illustrate an alternate chain tension sensor 1300.

One distinction between said chain tension sensor assembly 200 and said alternate chain tension sensor 1300 can comprise the movement of said first spring 408a, and said second spring 408b outside of said two sensor bases 502, as illustrated. Wherein, said two link sensor assemblies 400 can comprise two extensions 1302 at said link first end 404a, and said link second end 404b.

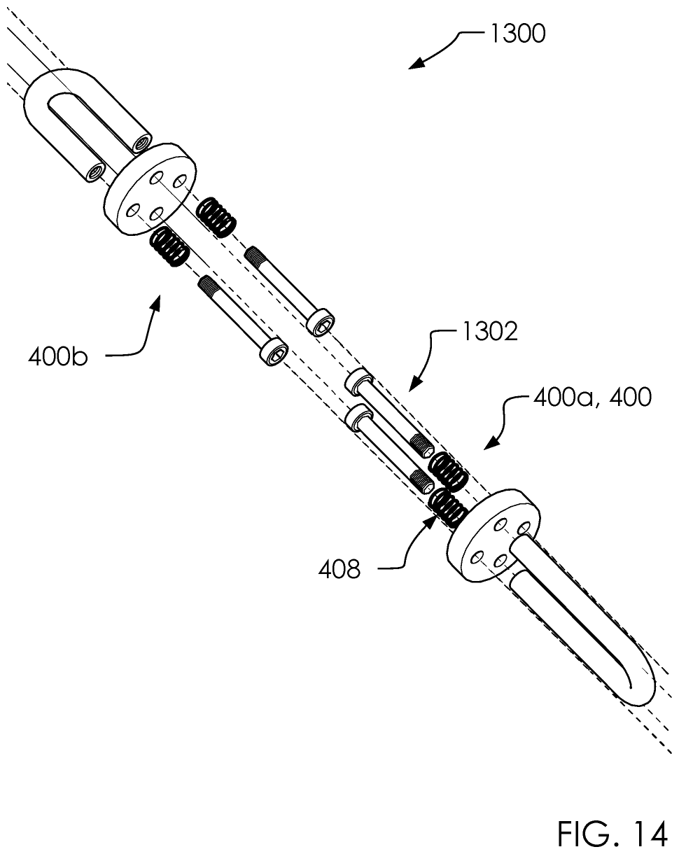

FIG. 14 illustrates an exploded perspective overview of said alternate chain tension sensor 1300.

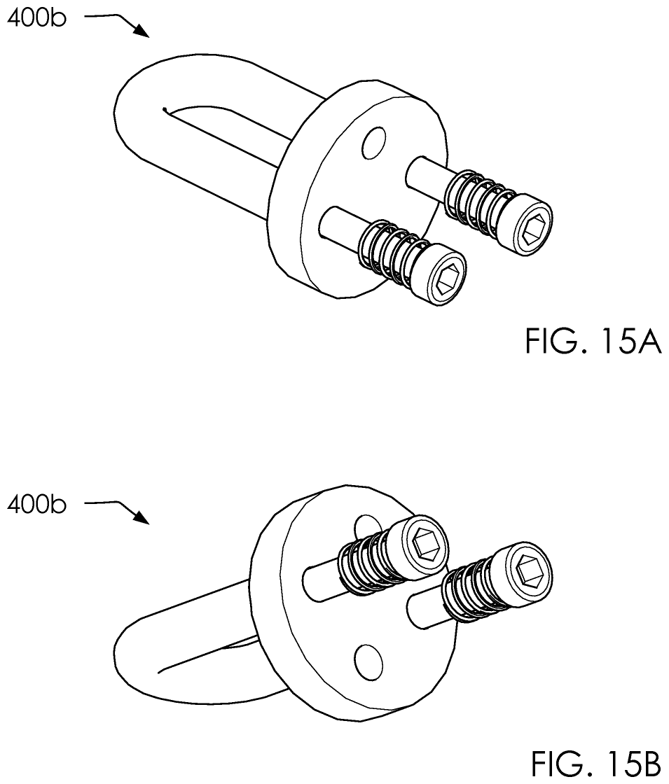

FIGS. 15A and 15B illustrate a perspective overview of said second link assembly 400b of said alternate chain tension sensor 1300.

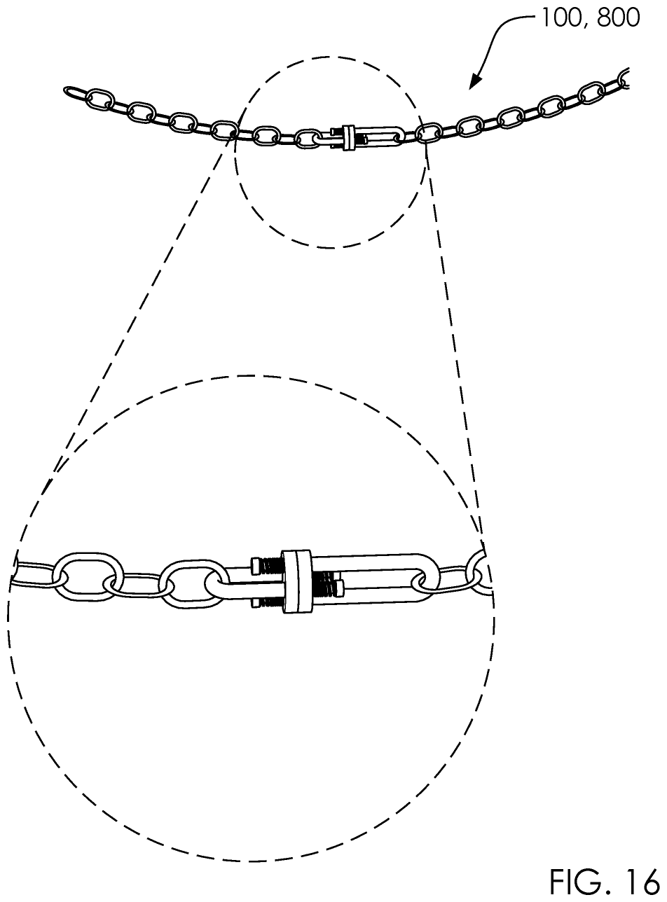

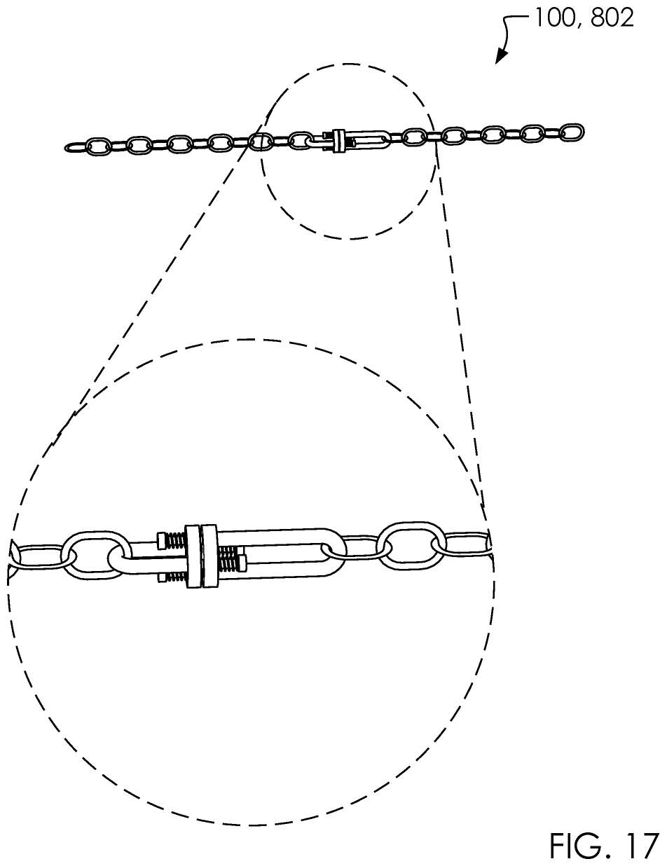

FIGS. 16 and 17 illustrate said alternate chain tension sensor 1300 in said relaxed configuration 800, and said range of intermediate pulled configurations 802, respectively.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

### PARTS LIST

said locomotive 104,
said mechanical brake assembly 100,
said chain 102,
said plurality of train cars 106,
said first car 106a,
said second car 106b,
said pulley based mechanical brake assembly 206,
said chain tension sensor assembly 200,
said non-engaged configuration 202,
said engaged configuration 204,
said wheel 208,
said chain box 210,
said brake pin assembly 212,
said brake cylinder 214,
said pulley 216,
said rocker based mechanical brake assembly 300,
said rocker 302,
said first chain 304,
said second chain 306,
said rotation axis 308,
said first chain receiver 310,
said second chain receiver 312,
said first link assembly 400a,
said second link assembly 400b,
said two link sensor assemblies 400,
said sensor-chain link 402,
said link first end 404a,
said link second end 404b,
said first spring 408a,
said second spring 408b,
said first fastener 412a,
said second fastener 412b,
said sensor base 416,
said link springs 408,
said enclosed end 418,
said open end 420,
said first threading 500a,
said second threading 500b,
said two sensor bases 502,
said one or more sensors 504,
said first axis 600a,
said second axis 600b,
said plurality of apertures 604,
said first aperture 604a,
said second aperture 604b,
said third aperture 604c,
said fourth aperture 604d,
said recessed portion 606,
said sensor controller 700,
said relaxed configuration 800,
said range of intermediate pulled configurations 802,
said spring force 804,
said chain force 806,
said fully compressed configuration 900,
said chain sensor address space 1200,
said one or more processors 1202,
said power system 1204,
said communication hardware 1206,
said memory 1208,
said device application 1210,
said pressure signal 1214,
said alternate chain tension sensor 1300, and
said two extensions 1302.

The following represents a preferred embodiment based on the original claims of this disclosure.

Said chain tension sensor assembly 200 for monitoring a tension in said chain 102 used in said mechanical brake assembly 100 on said locomotive 104. Said chain tension sensor assembly 200 comprises said two link sensor assemblies 400 arranged in series between said plurality of chain links 218. Said two link sensor assemblies 400 comprises said first link assembly 400a and said second link assembly 400b. Said chain tension sensor assembly 200 can be configured to monitor a tension in said chain 102 by installing said chain tension sensor assembly 200 in series between said plurality of chain links 218 and monitoring a force exerted on said chain tension sensor assembly 200 by portions of said chain 102. Each among said two link sensor assemblies 400 comprise at least said sensor-chain link 402 and said sensor base 416. Said sensor base 416 comprises said one or more sensors 504. Said chain tension sensor assembly 200 comprises said center axis 422 can be aligned an anticipated direction of tension applied on said two link sensor assemblies 400 along said chain 102. Said chain tension sensor assembly 200 can be configured to monitor said pressure signal 1214 from said one or more sensors 504 of said sensor base 416 of said two link sensor assemblies 400. Said sensor-chain link 402 comprises half enclosed shape having said enclosed end 418 and said open end 420. Said open end 420 can be between said link first end 404a and said link second end 404b, and said enclosed end 418 extends out and away from said open end 420. Each said sensor-chain link 402 can be configured to selectively attach to said sensor base 416 using said open end 420 and one or more fasteners. Said sensor-chain link 402 can be configured for passing through a portion of said sensor base 416 and securing said open end 420 to said sensor base 416 using said first fastener 412a on said link first end 404a and said second fastener 412b on said link second end 404b. Said sensor-chain link 402 can further be secured to said sensor base 416 using said link springs 408 arranged between said sensor base 416, said first fastener 412a and said second fastener 412b. Said link springs 408 comprise said first spring 408a and said second spring 408b. Said plurality of apertures 604 comprises said recessed portion 606 configured to allow a portion of said first spring 408a and said second spring 408b to slide within said sensor base 416. Said recessed portion 606 can ensure pressure on said one or more sensors 504 within said two sensor bases 502 does not destroy said one or more sensors 504 by ensuring said link springs 408 can fully compress without being smashed between said two sensor bases 502. Said first spring 408a and said second spring 408b can be configured to press said sensor base 416 of each said first link assembly 400a and said second link assembly 400b into one another as discussed herein. With said mechanical brake assembly 100 in said relaxed configuration 800, portions of said link springs 408 can rest within said sensor base 416. Whereas, with said mechanical brake assembly 100 in said range of intermediate pulled configurations 802, said link springs 408 can be squeezed within a portion or entirely within said recessed portion 606 of said plurality of apertures 604. Each said sensor base 416 of said first link assembly 400a and said second link assembly 400b can touch one another without crushing said link springs 408.

Said chain tension sensor assembly 200 for monitoring a tension in said chain 102 used in said mechanical brake assembly 100 on said locomotive 104. Said chain tension sensor assembly 200 comprises said two link sensor assemblies 400 arranged in series between said plurality of chain links 218. Said two link sensor assemblies 400 comprises said first link assembly 400a and said second link assembly 400b. Said chain tension sensor assembly 200 can be configured to monitor a tension in said chain 102 by installing said chain tension sensor assembly 200 in series between said plurality of chain links 218 and monitoring a force exerted on said chain tension sensor assembly 200 by portions of said chain 102. Each among said two link sensor assemblies 400 comprise at least said sensor-chain link 402 and said sensor base 416. Said sensor base 416 comprises said one or more sensors 504. Said chain tension sensor assembly 200 comprises said center axis 422 can be aligned an anticipated direction of tension applied on said two link sensor assemblies 400 along said chain 102. Said chain tension sensor assembly 200 can be configured to monitor said pressure signal 1214 from said one or more sensors 504 of said sensor base 416 of said two link sensor assemblies 400. Said sensor-chain link 402 comprises half enclosed shape having said enclosed end 418 and said open end 420. Said open end 420 can be between said link first end 404a and said link second end 404b, and said enclosed end 418 extends out and away from said open end 420. Each said sensor-chain link 402 can be configured to selectively attach to said sensor base 416 using said open end 420 and one or more fasteners. Said sensor-chain link 402 can be configured for passing through a portion of said sensor base 416 and securing said open end 420 to said sensor base 416 using said first fastener 412a on said link first end 404a and said second fastener 412b on said link second end 404b. Said sensor-chain link 402 can further be secured to said sensor base 416 using said link springs 408 arranged between said sensor base 416, said first fastener 412a and said second fastener 412b. Said link springs 408 comprise said first spring 408a and said second spring 408b. Said plurality of apertures 604 comprises said recessed portion 606 configured to allow a portion of said first spring 408a and said second spring 408b to slide within said sensor base 416. Said recessed portion 606 can ensure pressure on said one or more sensors 504 within said two sensor bases 502 does not destroy said one or more sensors 504 by ensuring said link springs 408 can fully compress without being smashed between said two sensor bases 502. Said first spring 408a and said second spring 408b can be configured to press said sensor base 416 of each said first link assembly 400a and said second link assembly 400b into one another as discussed herein. With said mechanical brake assembly 100 in said relaxed configuration 800, portions of said link springs 408 can rest within said sensor base 416. Whereas, with said mechanical brake assembly 100 in said range of intermediate pulled configurations 802, said link springs 408 can be squeezed within a portion or entirely within said recessed portion 606 of said plurality of apertures 604. Each said sensor base 416 of said first link assembly 400a and said second link assembly 400b can touch one another without crushing said link springs 408.

Said chain tension sensor assembly 200 for monitoring a tension in said chain 102 used in said mechanical brake assembly 100 on said locomotive 104. Said chain tension sensor assembly 200 comprises said two link sensor assemblies 400 arranged in series between said plurality of chain links 218. Said two link sensor assemblies 400 comprises said first link assembly 400a and said second link assembly 400b. Said chain tension sensor assembly 200 can be configured to monitor a tension in said chain 102 by installing said chain tension sensor assembly 200 in series between said plurality of chain links 218 and monitoring a force exerted on said chain tension sensor assembly 200 by portions of said chain 102. Each among said two link sensor assemblies 400 comprise at least said sensor-chain link 402 and said sensor base 416. Said sensor base 416 comprises said one or more sensors 504. Said chain tension sensor assembly 200 comprises said center axis 422 can be aligned an anticipated direction of tension applied on said two link sensor assemblies 400 along said chain 102. Said chain tension sensor assembly 200 can be configured to monitor said pressure signal 1214 from said one or more sensors 504 of said sensor base 416 of said two link sensor assemblies 400.

Said sensor-chain link 402 comprises half enclosed shape having said enclosed end 418 and said open end 420. Said open end 420 can be between said link first end 404a and said link second end 404b, and said enclosed end 418 extends out and away from said open end 420. Each said sensor-chain link 402 can be configured to selectively attach to said sensor base 416 using said open end 420 and one or more fasteners.

Said sensor-chain link 402 can be “U” shaped with said enclosed end 418 comprising a curved end of 402.

Said sensor-chain link 402 can be configured for passing through a portion of said sensor base 416 and securing said open end 420 to said sensor base 416 using said first fastener 412a on said link first end 404a and said second fastener 412b on said link second end 404b. Said sensor-chain link 402 can further be secured to said sensor base 416 using said link springs 408 arranged between said sensor base 416, said first fastener 412a and said second fastener 412b. Said link springs 408 comprise said first spring 408a and said second spring 408b.

Said plurality of apertures 604 comprises said recessed portion 606 configured to allow a portion of said first spring 408a and said second spring 408b to slide within said sensor base 416. Said recessed portion 606 can ensure pressure on said one or more sensors 504 within said two sensor bases 502 does not destroy said one or more sensors 504 by ensuring said link springs 408 can fully compress without being smashed between said two sensor bases 502. Said first spring 408a and said second spring 408b can be configured to press said sensor base 416 of each said first link assembly 400a and said second link assembly 400b into one another as discussed herein. With said mechanical brake assembly 100 in said relaxed configuration 800, portions of said link springs 408 can rest within said sensor base 416. Whereas, with said mechanical brake assembly 100 in said range of intermediate pulled configurations 802, said link springs 408 can be squeezed within a portion or entirely within said recessed portion 606 of said plurality of apertures 604. Each said sensor base 416 of said first link assembly 400a and said second link assembly 400b can touch one another without crushing said link springs 408.

Said sensor-chain link 402 comprises said first threading 500a and said second threading 500b on said link first end 404a, and said link second end 404b, respectively. Each among said first threading 500a and said second threading 500b can be threaded and configured to selectively attach to said first fastener 412a, and said second fastener 412b, respectively.

Said sensor-chain link 402 of said first link assembly 400a and said sensor-chain link 402 of said second link assembly 400b can be aligned with one another along said center axis 422 and rotated 90 degrees relative to one another about said center axis 422. Said link first end 404a and said link second end 404b overlap with one another but do not interfere with one another being out of phase.

Said link first end 404a, and said link second end 404b of said sensor-chain link 402 can be aligned with said first axis 600a and said second axis 600b, respectively. Said sensor base 416 comprises said plurality of apertures 604 comprising said first aperture 604a, said second aperture 604b, said third aperture 604c, and said fourth aperture 604d. Said link first end 404a, and said link second end 404b of said two link sensor assemblies 400 can pass through said plurality of apertures 604. Said plurality of apertures 604 comprises two sets of two aperture each aligned 90 degrees out of phase from one another about said center axis 422.

Said chain tension sensor assembly 200 comprises said two sensor bases 502 comprising said sensor base 416 of said first link assembly 400a and said sensor base 416 of said second link assembly 400b. Said two sensor bases 502 can be configured to extend through a portion of both said sensor-chain link 402 of said first link assembly 400a and said second link assembly 400b. Said two sensor bases 502 can each comprise said one or more sensors 504 configured to measure a proximity between said two sensor bases 502.

Said chain tension sensor assembly 200 can be configured for transitioning between said relaxed configuration 800, said range of intermediate pulled configurations 802 and said fully compressed configuration 900. Said chain tension sensor assembly 200 can be configured for measuring a relative proximity between said sensor base 416 of said first link assembly 400a and said second link assembly 400b. With said chain tension sensor assembly 200 in said fully compressed configuration 900, said sensor base 416 of each said two link sensor assemblies 400 can be pulled completely against one another with said one or more sensors 504 at a minimum distance from one another.

Each among said two sensor bases 502 comprises said sensor controller 700. Said sensor controller 700 comprises a computer configured to collect and report a status of said one or more sensors 504 of said sensor base 416 of said two link sensor assemblies 400.

Said sensor controller 700 comprises at least said one or more processors 1202, said power system 1204, and said memory 1208 having said device application 1210. Said one or more sensors 504 can be configured to create said pressure signal 1214 associated with a tension on said chain tension sensor assembly 200 by said chain 102. Said pressure signal 1214 can be utilized to determine whether said chain tension sensor assembly 200 can be in said fully compressed configuration 900, said range of intermediate pulled configurations 802 and said relaxed configuration 800. Said device application 1210 receives said pressure signal 1214 and calculates a state of said chain tension sensor assembly 200.

Said sensor controller 700 further comprises said communication hardware 1206 to communicate said pressure signal 1214 and a status of said chain tension sensor assembly 200 to other computers.

Said pressure signal 1214 comprises a pressure between said sensor base 416 of said first link assembly 400a and said second link assembly 400b.

1. A chain tension sensor assembly for monitoring a tension in a chain used in a mechanical brake assembly on a locomotive, wherein:
said chain tension sensor assembly comprises two link sensor assemblies arranged in series between a plurality of chain links;
said two link sensor assemblies comprises a first link assembly and a second link assembly;
said chain tension sensor assembly is configured to monitor a tension in said chain by
installing said chain tension sensor assembly in series between said plurality of chain links and
monitoring a force exerted on said chain tension sensor assembly by portions of said chain;
each among said two link sensor assemblies comprise at least a sensor-chain link and a sensor base;
said sensor base comprises one or more sensors;
said chain tension sensor assembly comprises a center axis is aligned an anticipated direction of tension applied on said two link sensor assemblies along said chain;
said chain tension sensor assembly is configured to monitor a pressure signal from said one or more sensors of said sensor base of said two link sensor assemblies;
said sensor-chain link comprises half enclosed shape having an enclosed end and an open end;
said open end is between a link first end and a link second end, and said enclosed end extends out and away from said open end;
each said sensor-chain link is configured to selectively attach to said sensor base using said open end and one or more fasteners;
said sensor-chain link is configured for
passing through a portion of said sensor base and
securing said open end to said sensor base using a first fastener on said link first end and a second fastener on said link second end;
said sensor-chain link can further be secured to said sensor base using link springs arranged between said sensor base, said first fastener and said second fastener;
said link springs comprise a first spring and a second spring;
a plurality of apertures comprises a recessed portion configured to allow a portion of said first spring and said second spring to slide within said sensor base;
said recessed portion can ensure pressure on said one or more sensors within two sensor bases does not destroy said one or more sensors by ensuring said link springs can fully compress without being smashed between said two sensor bases;
said first spring and said second spring are configured to press said sensor base of each said first link assembly and said second link assembly into one another as discussed herein;
with said mechanical brake assembly in a relaxed configuration, portions of said link springs can rest within said sensor base; whereas, with said mechanical brake assembly in a range of intermediate pulled configurations, said link springs is squeezed within a portion or entirely within said recessed portion of said plurality of apertures; and
each said sensor base of said first link assembly and said second link assembly can touch one another without crushing said link springs.

2. A chain tension sensor assembly for monitoring a tension in a chain used in a mechanical brake assembly on a locomotive, wherein:
said chain tension sensor assembly comprises two link sensor assemblies arranged in series between a plurality of chain links;
said two link sensor assemblies comprises a first link assembly and a second link assembly;
said chain tension sensor assembly is configured to monitor a tension in said chain by
installing said chain tension sensor assembly in series between said plurality of chain links and
monitoring a force exerted on said chain tension sensor assembly by portions of said chain;
each among said two link sensor assemblies comprise at least a sensor-chain link and a sensor base;
said sensor base comprises one or more sensors;
said chain tension sensor assembly comprises a center axis is aligned an anticipated direction of tension applied on said two link sensor assemblies along said chain; and
said chain tension sensor assembly is configured to monitor a pressure signal from said one or more sensors of said sensor base of said two link sensor assemblies.

3. The chain tension sensor assembly of claim 2, wherein:
said sensor-chain link comprises half enclosed shape having An enclosed end and an open end;
said open end is between a link first end and a link second end, and said enclosed end extends out and away from said open end; and
each said sensor-chain link is configured to selectively attach to said sensor base using said open end and one or more fasteners.

4. The chain tension sensor assembly of claim 3, wherein:
said sensor-chain link is “U” shaped with said enclosed end comprising a curved end of 402.

5. The mechanical brake assembly of claim 3, wherein:
said sensor-chain link is configured for
passing through a portion of said sensor base and
securing said open end to said sensor base using A first fastener on said link first end and a second fastener on said link second end;
said sensor-chain link can further be secured to said sensor base using link springs arranged between said sensor base, said first fastener and said second fastener; and
said link springs comprise a first spring and a second spring.

6. The chain tension sensor assembly of claim 5, wherein:
A plurality of apertures comprises a recessed portion configured to allow a portion of said first spring and said second spring to slide within said sensor base;
said recessed portion can ensure pressure on said one or more sensors within two sensor bases does not destroy said one or more sensors by ensuring said link springs can fully compress without being smashed between said two sensor bases;
said first spring and said second spring are configured to press said sensor base of each said first link assembly and said second link assembly into one another as discussed herein;
with said mechanical brake assembly in a relaxed configuration, portions of said link springs can rest within said sensor base; whereas, with said mechanical brake assembly in a range of intermediate pulled configurations, said link springs is squeezed within a portion or entirely within said recessed portion of said plurality of apertures; and
each said sensor base of said first link assembly and said second link assembly can touch one another without crushing said link springs.

7. The chain tension sensor assembly of claim 3, wherein:
said sensor-chain link comprises A first threading and a second threading on said link first end, and said link second end, respectively; and
each among said first threading and said second threading is threaded and configured to selectively attach to said first fastener, and said second fastener, respectively.

8. The chain tension sensor assembly of claim 3, wherein:
said sensor-chain link of said first link assembly and said sensor-chain link of said second link assembly are aligned with one another along said center axis and rotated 90 degrees relative to one another about said center axis; and
said link first end and said link second end overlap with one another but do not interfere with one another being out of phase.

9. The chain tension sensor assembly of claim 8, wherein:
said link first end, and said link second end of said sensor-chain link are aligned with A first axis and a second axis, respectively;
said sensor base comprises said plurality of apertures comprising a first aperture, a second aperture, a third aperture, and a fourth aperture;
said link first end, and said link second end of said two link sensor assemblies can pass through said plurality of apertures; and
said plurality of apertures comprises two sets of two aperture each aligned 90 degrees out of phase from one another about said center axis.

10. The chain tension sensor assembly of claim 2, wherein:
said chain tension sensor assembly comprises said two sensor bases comprising said sensor base of said first link assembly and said sensor base of said second link assembly;
said two sensor bases are configured to extend through a portion of both said sensor-chain link of said first link assembly and said second link assembly; and
said two sensor bases can each comprise said one or more sensors configured to measure a proximity between said two sensor bases.

11. The chain tension sensor assembly of claim 2, wherein:
said chain tension sensor assembly is configured for transitioning between said relaxed configuration, said range of intermediate pulled configurations and A fully compressed configuration;
said chain tension sensor assembly is configured for measuring a relative proximity between said sensor base of said first link assembly and said second link assembly; and
with said chain tension sensor assembly in said fully compressed configuration, said sensor base of each said two link sensor assemblies is pulled completely against one another with said one or more sensors at a minimum distance from one another.

12. The chain tension sensor assembly of claim 2, wherein:
each among said two sensor bases comprises a sensor controller; and
said sensor controller comprises a computer configured to collect and report a status of said one or more sensors of said sensor base of said two link sensor assemblies.

13. The chain tension sensor assembly of claim 12, wherein:
said sensor controller comprises at least One or more processors, a power system, and a memory having a device application;
said one or more sensors are configured to create said pressure signal associated with a tension on said chain tension sensor assembly by said chain;
said pressure signal is utilized to determine whether said chain tension sensor assembly is in said fully compressed configuration, said range of intermediate pulled configurations and said relaxed configuration; and
said device application receives said pressure signal and calculates a state of said chain tension sensor assembly.

14. The chain tension sensor assembly of claim 13, wherein:
said sensor controller further comprises A communication hardware to communicate said pressure signal and a status of said chain tension sensor assembly to other computers.

15. The chain tension sensor assembly of claim 13, wherein:
said pressure signal comprises a pressure between said sensor base of said first link assembly and said second link assembly.

16. A chain tension sensor assembly for monitoring a tension in a chain used in a mechanical brake assembly on a locomotive, wherein:
said chain tension sensor assembly comprises two link sensor assemblies arranged in series between a plurality of chain links;
said two link sensor assemblies comprises a first link assembly and a second link assembly;
said chain tension sensor assembly is configured to monitor a tension in said chain by
installing said chain tension sensor assembly in series between said plurality of chain links and
monitoring a force exerted on said chain tension sensor assembly by portions of said chain;
each among said two link sensor assemblies comprise at least a sensor-chain link and a sensor base;
said sensor base comprises one or more sensors;
said chain tension sensor assembly comprises a center axis is aligned an anticipated direction of tension applied on said two link sensor assemblies along said chain;
said chain tension sensor assembly is configured to monitor a pressure signal from said one or more sensors of said sensor base of said two link sensor assemblies;
said sensor-chain link comprises half enclosed shape having an enclosed end and an open end;
said open end is between a link first end and a link second end, and said enclosed end extends out and away from said open end;
each said sensor-chain link is configured to selectively attach to said sensor base using said open end and one or more fasteners;
each among two sensor bases comprises a sensor controller;
said sensor controller comprises a computer configured to collect and report a status of said one or more sensors of said sensor base of said two link sensor assemblies;
said sensor controller comprises at least one or more processors, a power system, and a memory having a device application;
said one or more sensors are configured to create said pressure signal associated with a tension on said chain tension sensor assembly by said chain;
said pressure signal is utilized to determine whether said chain tension sensor assembly is in a fully compressed configuration, a range of intermediate pulled configurations and a relaxed configuration; and
said device application receives said pressure signal and calculates a state of said chain tension sensor assembly.
